(19) United States
(12) Patent Application Publication
(10) Pub. No.: US 2005/0076740 A1
(43) Pub. Date: Apr. 14, 2005

(54) Connecting rod with reverse drilled oil squirt hole

(76) Inventors: George W. Ford, Rochester Hills, MI (US); Gary M. Kantrud, Fenton, MI (US); John M. Beardmore, Howell, MI (US); Theodore B. Purdy, Commerce, MI (US)

Correspondence Address: LESLIE C. HODGES;General Motors Corporation, Legal Staff, Mail Code 482-C23-B21, P.O. Box 300, Detroit, MI, 48265-3000, US

(21) Appl. No.: 10/682,285

(22) Filed: Oct. 9, 2003

(51) Int. Cl. G05G 1/00

(52) U.S. Cl. 74/587

(57) ABSTRACT

A connecting rod for an engine includes a connecting rod body having a pin bore formed in one end and a crank arm bore formed in an opposite end. The opposite end has a squirt hole formed therethrough with a first end of the squirt hole facing the crank arm bore and a second end of the squirt hole facing away from the connecting rod at a desired angle for squirting oil. The second end of the squirt hole has a diameter at least as large as the first end of the squirt hole. Accordingly, the squirt hole is drilled from outside the connecting rod without removing the cap.

### TECHNICAL FIELD

The present invention relates to a connection rod having an oil squirt hole which is drilled from outside the connecting rod without removing the cap.

### BACKGROUND OF THE INVENTION

In recent years, piston noise complaints have been on the rise. Piston noise includes “piston slap” and wrist pin knock or rattle. These noises are most frequently generated upon cold starting of the engine, but can also be manifest on hot restarts. Objection to piston noise continues to be a source of customer complaints. Even though normal piston noise is not indicative of eminent mechanical failure, customers may deem it as unacceptable and the engine as lacking quality.

Modern piston noise can be attributed to lateral instability of the piston assembly and lack of sufficient lubrication within the critical interfaces of the piston-to-bore and wrist pin joints. Severe packaging constraints and ever increasing power demands have led to very short piston designs with rotund skirt profiles. Furthermore, a challenging high temperature environment now exists for the piston and pin, which requires some means for supplemental cooling. In the past, the automotive piston/pin assembly has relied primarily on “splash” lubrication for cooling and noise control. However, relatively dry cylinder bores and pin joints have resulted for a number of reasons. Most notable of these contributors are tight crank bearing clearances (for low crank system noise) and aggressive piston ring designs (for reduced oil consumption). Unfortunately, these necessary refinements exacerbate the dry scenario for the reciprocating hardware. This is especially the case upon engine start up, as immediate lubrication is critical for “cushioning” the relevant interfaces involved with piston noise.

The advent of polymer coated piston skirts has enabled much tighter piston fit tolerances, which has addressed the aspect of piston stability with a remarkable reduction in piston noise. However, pin noise remains and piston noises can still be of concern in certain instances. Therefore, additional lubrication has become a fundamental requirement for the contemporary high performance engine. The most viable means of supplying added lube to the reciprocating hardware include rifle drilled rods, full time block mounted piston oilers, and connecting rod squirters. Full time block squirters consist of a nozzle that is mounted in the crankcase, near the bottom of each cylinder, which directs a steady stream of oil to the bottom side of the piston dome. To alleviate excessive demands on the oil pump, usually the nozzle head incorporates a check ball valve assembly. These check valves typically begin to flow when the supply pressure exceeds around 25 psi (175 kPa). The main benefit of block squirters is that of piston cooling, which can lower critical piston surface temperatures by 30° C. Disadvantages of common block squirters are that their targeting is much less effective for cold noise control, and they are difficult to package. Quite often, block squirters mandate that a notch be provided at the lower end of the piston skirt for clearance at bottom dead center. This is undesirable as it creates a stress riser in an area of the piston skirt, which is already under high stress. Further, block squirters are typically more expensive to implement and somewhat more likely to malfunction due to a plugged or sticky check valve.

Rifle drilled rods are less frequently employed in automotive engines than block squirters. This design includes a passage drilled through the entire length of the rod's column, thus connecting the wrist pin end to the big end of the rod. Oil is fed up through the center of the rod and directed as necessary to facilitate pin lubrication and/or to cool the piston under-dome. This technology is often used in large HD diesel engines. Its main advantage is communicating lubricant directly and internally right to the point of use for maximum effectiveness. The largest deterrents to gun drilled rods is the cost associated with drilling such a long, small diameter passage. The scrap rate can be excessive in weight conscious designs.

The most popular means for supplying added lube to the reciprocating hardware is connecting rod squirters, which incorporate a small orifice along the side of the rod. Rod squirters emit an intermittent spurt of oil, once per engine revolution, whenever the squirter hole in the rod aligns with the drilled lube passage in the crank's rod journal. Properly timed and targeted, the rod squirter can provide ample lube for the piston squirt thrust surfaces as well as for the wrist pin joints. The main advantages of rod squirters are that they usually package better than block squirters and do not place a huge demand on the oil supply system (i.e., the oil pump). Additionally, rod squirters are generally less expensive than block squirters.

Conventional rod squirters are typically step drilled from the inside of the crank arm bore when the cap is removed. However, every time the cap is removed, there is an increasing propensity for error in further processing and subsequent assembly. Thus, adding rod squirters may be impractical under certain design circumstances.

### SUMMARY OF THE INVENTION

It has been surprisingly discovered that the drilling operation of the rod squirter can be reversed so that the drilling can be performed without removal of the cap, which is important for maintaining quality and economy. Testing has confirmed that overall performance of the reversed drilled oil squirter is identical to that of the conventional oil squirter.

One aspect of the invention provides a connecting rod in which the cap is removed from the connecting rod body by fracturing, and wherein the oil rod squirt hole is drilled from outside the connecting rod without removing the cap. Removing and replacing the connecting rod cap is a very undesirable step in the traditional process for adding an oil squirt hole to a connecting rod, and it is especially undesirable when the rod design is such that the cap removal during manufacturing is done by fracturing. This is because the alignment feature of the cap to the rod is the fractured surface, which may be damaged by the extra removal and reassembly of the cap. Accordingly, this aspect of the invention provides significant advantages over prior art methods.

Another aspect of the invention provides a connecting rod for an engine including a connecting rod body having a pin bore formed in one end and a crank arm bore formed in an opposite end. The opposite end has a squirt hole formed therethrough with a first end of the squirt hole facing the crank arm bore and a second end of the squirt hole facing away from the connecting rod at a desired angle for squirting oil. The second end of the squirt hole has a diameter at least as large as the diameter of the first end of the squirt hole.

In a step drilling operation, the squirt hole is drilled such that the diameter of the second end of the squirt hole is greater than the diameter of the first end of the squirt hole. The crank arm bore may also include a burr catcher pocket intersecting the first end of the squirt hole to prevent the formation of burrs in the machining of the crank arm bore.

In an alternative embodiment, a nozzle may be pressed into the squirt hole. Preferably, the nozzle is approximately 6 millimeters in length and has a nozzle hole of approximately 1.5 millimeters. The nozzle may comprise material selected from the group consisting of copper, brass and aluminum.

A method in accordance with the invention includes the steps of: (A) forming a body having a pin bore at one end and a crank arm bore at an opposite end, wherein the body has a cap portion forming the crank arm bore; and (B) drilling an oil squirt hole into the body from the outside without removing the cap portion.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 shows a schematic plan view of a connecting rod in accordance with the present invention;

FIG. 2 shows a schematic perspective view of the connecting rod of FIG. 1;

FIG. 3 shows a schematic plan view of a connecting rod having a squirter nozzle in accordance with an alternative embodiment of the invention; and

FIG. 4 shows a schematic flow diagram illustrating methods of manufacturing a connecting rod in accordance with the invention.

### DESCRIPTION OF THE PREFERRED EMBODIMENTS

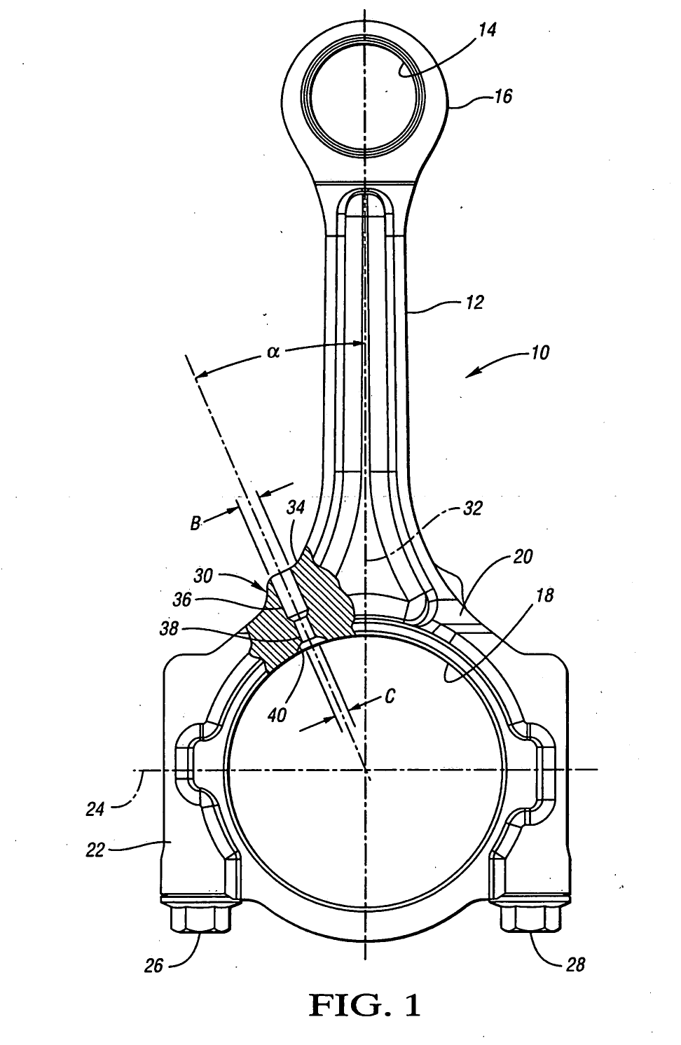

Referring to FIG. 1, a connecting rod 10 is shown in accordance with the invention. The connecting rod 10 includes a body 12 having a pin bore 14 formed in one end 16 and a crank arm bore 18 formed in an opposite end 20. The opposite end 20 includes a cap 22 which is separated from the body 12 along the fracture line 24, and then reattached to the body 12 by bolts 26, 28.

The fracture line 24 is the result of a fracturing process which includes inserting an expander into the crank arm bore 18, and expanding until the connecting rod body fractures along the fracture line 24.

A squirt hole 30 is formed through the body 12 and intersects the crank arm bore 18. The squirt hole 30 is drilled from outside the connecting rod 10 while the cap 22 is attached to the body 12. The squirt hole 30 is formed at an angle A relative to the center line 32 of the body 12. The angle A is selected to optimize targeting of the oil spray. The squirt hole 30 is preferably drilled in a two-step drilling process against the drilling land 34. The first step is to drill the bore 36, which has a diameter B of approximately 4 millimeters. The bore 38 is then drilled to intersect the crank arm bore 18. The bore 38 has a diameter C of preferably 1.5 millimeters. Preferably, the length to diameter ratio of the narrower bore 38 is 4:1. Because the squirt hole 30 is drilled from the outside, the diameter C will always be less than or equal to the diameter B.

As further shown in FIG. 1, a burr catcher pocket 40 is formed in the crank arm bore 18 intersecting the bore 38. The burr catcher pocket 40 is preferably formed using a 6 millimeter ball cutter to provide a burr catcher for crankshaft bore machining. The ball cutter is inserted at an angle over the rod cap to reach the inside of the crankshaft bore without removing the rod cap 22.

Accordingly, the squirt hole 30 is added to the connecting rod prior to finish machining of the rod and without the removal of the rod cap 22 at any step of the process. Also, with the burr catcher pocket 40, finish honing of the crankshaft bore 18 can be completed without the addition of a deburring operation on the squirt hole.

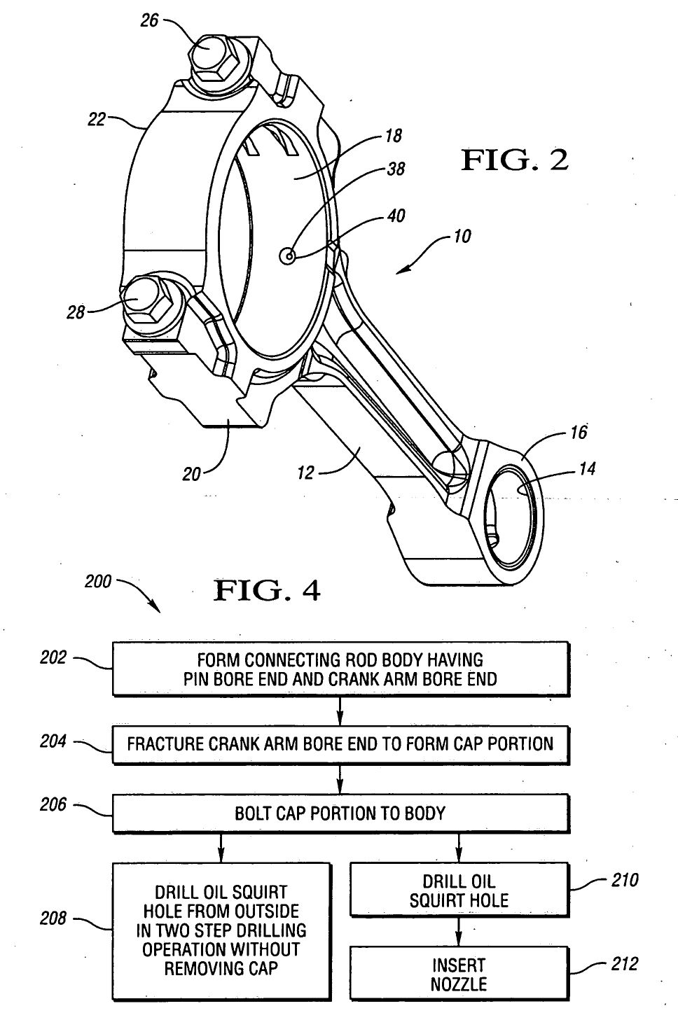

FIG. 2 shows a perspective view of the connecting rod 10 of FIG. 1, and particularly illustrates the bore 38 and burr catcher pocket 40 formed in the crank arm bore 18.

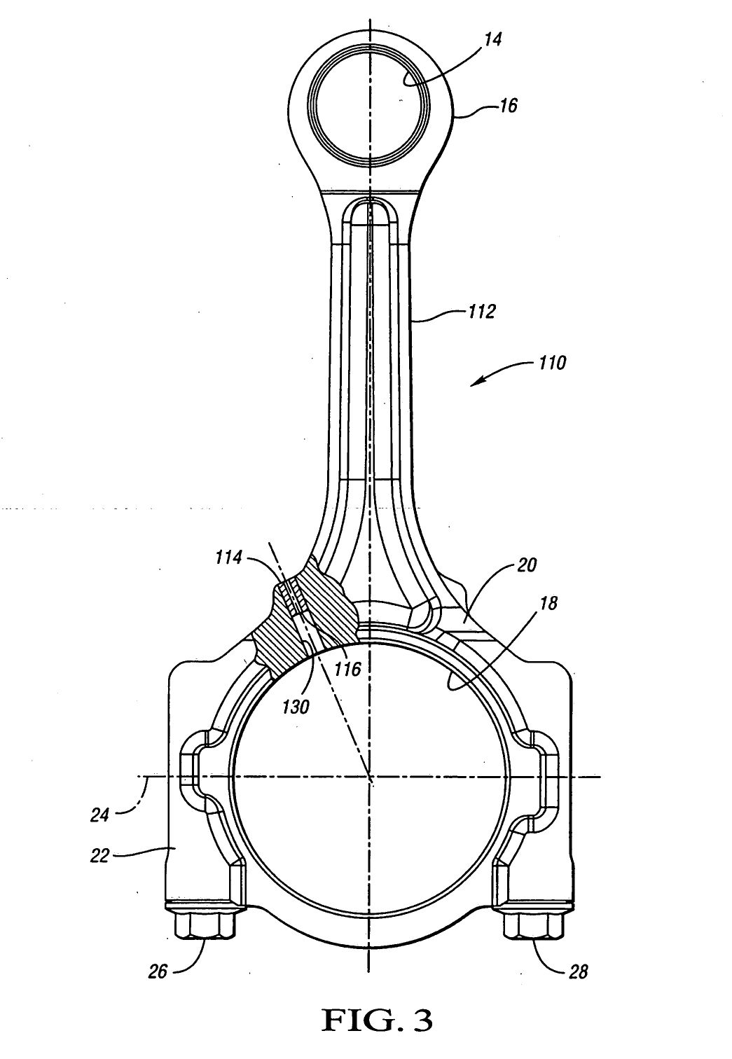

Turning to FIG. 3, a connecting rod 110 is shown in accordance with an alternative embodiment of the invention, wherein like reference numerals are used to refer to like components from FIG. 1. As shown, the body 112 includes a single squirt hole 130 having a continuous diameter from outside the connecting rod 110 to the interface with the crank arm bore 18 (i.e., a continuous diameter from end to end). A nozzle 114 is pressed into the squirt hole 130, and includes a nozzle hole 116 which is approximately 6 millimeters long and 1.5 millimeters in diameter. The nozzle 114 may be copper, brass or aluminum, and is pressed into the squirt hole 130 with an appropriate interference fit with the hole 130. The squirt hole 130 preferably has a diameter of about 4 millimeters.

Turning to FIG. 4, a schematic illustration is shown of a method 200 for manufacturing a connecting rod in accordance with the invention. First, a connecting rod body is formed having a pin bore end and a crank arm bore end (step 202). The crank arm bore end is then fractured (step 204) to form a cap portion. The cap portion is then bolted back to the body (step 206). However, the invention is not limited to fractured cap rods. An oil squirt hole may then be drilled from outside the connecting rod in a two-step drilling operation without removing the cap (step 208). Alternatively, an oil squirt hole may be drilled (step 210), and a nozzle inserted therein (step 212).

Further details regarding the manufacture of connecting rods may be found, for example, in U.S. Pat. No. 5,946,790, which is hereby incorporated by reference in its entirety.

While the best modes for carrying out the invention have been described in detail, those familiar with the art to which this invention relates will recognize various alternative designs and embodiments for practicing the invention within the scope of the appended claims.

1. A connecting rod for an engine comprising:
a connecting rod body having a pin bore formed in one end and a crank arm bore formed in an opposite end;
wherein said opposite end has a squirt hole formed therethrough with a first end of the squirt hole facing the crank arm bore and a second end of the squirt hole facing away from the connecting rod at a desired angle for squirting oil; and
wherein said second end of the squirt hole has a diameter at least as large as the diameter of said first end of the squirt hole.

2. The connecting rod of claim 1, wherein said diameter of the second end of the squirt hole is greater than said diameter of the first end of the squirt hole.

3. The connecting rod of claim 1, wherein said squirt hole is stepped as a result of a two-step drilling operation to form said diameters.

4. The connecting rod of claim 1, wherein said crank arm bore includes a burr catcher pocket intersecting the first end of the squirt hole to prevent the formation of burrs in the machining of the crank arm bore.

5. The connecting rod of claim 1, wherein said opposite end includes a cap portion partially forming said crank arm bore.

6. The connecting rod of claim 5, wherein said cap is separated from the body by a fracture, and is bolted to the body.

7. The connecting rod of claim 1, wherein said diameters of the first and second ends of the squirt hole are equal, and the connecting rod further comprises a nozzle pressed into the squirt hole.

8. The connecting rod of claim 7, wherein said nozzle is appropriately 6 millimeters in length.

9. The connecting rod of claim 7, wherein the nozzle has a nozzle hole with a length to diameter ratio of approximately 4:1.

10. The connecting rod of claim 7, wherein said nozzle comprises a material selected from the group consisting of copper, brass and aluminum.

11. The connecting rod of claim 7, wherein said nozzle is secured in the squirt hole by an interference fit.

12. The connecting rod of claim 1, wherein said squirt hole is drilled into the body from the outside while a cap is attached to the body to partially form said crank arm bore.

13. A connecting rod for an engine comprising:
a connecting rod body having a pin bore formed in one end and a crank arm bore formed in an opposite end;
wherein said opposite end has a squirt hole formed therethrough with a first end of the squirt hole facing the crank arm bore and a second end of the squirt hole facing away from the connecting rod at a desired angle for squirting oil;
wherein said second end of the squirt hole has a diameter at least as large as the diameter of said first end of the squirt hole; and
wherein a cap portion of the body is fractured for separation from the body, and then bolted onto the body to form the crank arm bore.

14. The connecting rod of claim 13, wherein said diameter of the second end of the squirt hole is greater than said diameter of the first end of the squirt hole.

15. The connecting rod of claim 14, wherein said squirt hole is stepped as a result of a two-step drilling operation to form said diameters.

16. The connecting rod of claim 13, wherein said crank arm bore includes a burr catcher pocket intersecting the first end of the squirt hole to prevent the formation of burrs in the machining of the crank arm bore.

17. The connecting rod of claim 13, wherein said diameters of the first and second ends of the squirt hole are equal, and the connecting rod further comprises a nozzle pressed into the squirt hole.

18. The connecting rod of claim 13, wherein said squirt hole is drilled into the body from the outside while said cap portion is attached to the body to partially form said crank arm bore.

19. A method of manufacturing a connecting rod comprising:
forming a body having a pin bore in one end and a crank arm bore in an opposite end, wherein said body has a cap portion partially forming the crank arm bore; and
drilling an oil squirt hole into the body from the outside without removing the cap portion.

20. The method of claim 19, wherein said drilling comprises first drilling a relatively large hole partially through the body, and then drilling a smaller hole connecting the large hole with the crank arm bore.

21. The method of claim 19, further comprising fracturing the body to form a cap portion at said opposite end, and bolting said cap portion to the body.

22. The method of claim 19, further comprising machining a burr catcher pocket in the crank arm bore intersecting the first end of the squirt hole to prevent the formation of burrs during machining of the crank arm bore.

23. The method of claim 19, further comprising pressing a nozzle into the squirt hole.
